(19) United States
(12) Patent Application Publication
(10) Pub. No.: US 2016/0347668 A1
(43) Pub. Date: Dec. 1, 2016

(54) POLYCRYSTALLINE DIAMOND COMPACT

(71) Applicant: ILJIN DIAMOND CO., LTD., Eumseong (KR)

(72) Inventors: Hui Soo JUN, Cheongju (KR); Hee Sub PARK, Suwon (KR)

(73) Assignee: ILJIN DIAMOND CO., LTD., Eumseong (KR)

(21) Appl. No.: 15/113,826

(22) PCT Filed: Feb. 10, 2015
(86) PCT No.: PCT/KR2015/001327

§ 371 Date: Jul. 23, 2016

(30) Foreign Application Priority Data
Feb. 11, 2014 (KR) 10-2014-0015257

(51) Int. Cl. C04B 35/52; E21B 10/573; C04B 35/64; C04B 35/56; C04B 35/622

(52) U.S. Cl. CPC C04B 35/52; C04B 35/5626; C04B 35/62222; C04B 35/64; E21B 10/5735; C04B 2235/427; C04B 2235/3843; C04B 2235/3847; C04B 2237/363; C04B 2237/36; C04B 2237/588; C04B 2237/704

(57) ABSTRACT

The present invention relates to a polycrystalline diamond compact. A method for manufacturing a polycrystalline diamond compact includes: assembling a first diamond powder on a carbide substrate; preliminarily sintering the assembled carbide substrate and the first diamond powder on the carbide substrate to form a first polycrystalline diamond layer on the carbide substrate; assembling a second diamond powder having a particle diameter in the range of 0.1 μm to 5 μm on the first polycrystalline diamond layer; and sintering the assembled carbide substrate, the first polycrystalline diamond layer, and the second diamond powder on the first polycrystalline diamond layer to form a second polycrystalline diamond layer on the first polycrystalline diamond layer. The content of a metal binder (catalyst) in a portion which is used in bedrock cutting during actual drilling, that is, a superficial portion of the polycrystalline diamond layer, is controlled to be minimized.

### TECHNICAL FIELD

The present invention relates to a polycrystalline diamond compact, and more particularly, to a polycrystalline diamond compact with improved wear resistance and impact resistance.

### BACKGROUND ART

A polycrystalline diamond sintered body (PCD), particularly, a polycrystalline diamond compact (PDC) is widely used in cutting, milling, grinding, drilling, and the like. The PDC is manufactured with diamond particles on a carbide substrate by metal catalysts under high temperature and high pressure. However, cracks and breakage are generated at a high temperature by a difference in thermal expansion coefficient between the diamond particles and the metal catalysts (binders) configuring the PDC.

In detail, the PDC is generally manufactured by sintering the diamond and the cemented substrate under high temperature and high pressure and diffusing the metal catalyst (binder) during sintering. The metal binder of the cemented substrate serves to increase bonds between diamonds during sintering, but corresponds to a foreign substance which has a bad effect on tool performance after the PDC is manufactured.

The PDC used in a drill bit for an oil well is subjected to hot heat during drilling and the diamond bonds are broken due to the difference in thermal expansion coefficient between the diamond and the metal binder. As an operating environment is gradually deteriorated, a polycrystalline diamond compact having excellent performance capable of minimizing the cracks has been required. In a manufacturer of the polycrystalline diamond compact, in order to solve the problem of the poor performance, techniques for removing the metal binder or reducing the content of the catalyst have been required and moreover, techniques for improving both impact resistance and sinterability have been developed.

### SUMMARY OF INVENTION

The present invention is directed to provide a polycrystalline diamond compact and a method for manufacturing the same capable of increasing heat resistance and improving wear resistance and impact resistance by controlling the content of a catalyst in a portion which is used in bedrock cutting during actual drilling.

The present invention is also directed to provide a polycrystalline diamond compact with improved sinterability and a method for manufacturing the same so as to solve structural instability according to a multilayered structure while introducing the multilayered structure with balanced heat resistance, wear resistance, and impact resistance.

### Technical Solution

An aspect of the present invention provides a method for manufacturing a polycrystalline diamond compact, comprising: a first assembling step of assembling a first diamond powder on a carbide substrate; a first sintering step of preliminarily sintering the assembled carbide substrate and the first diamond powder on the carbide substrate to form a first polycrystalline diamond layer on the carbide substrate; a second assembling step of assembling a second diamond powder having a particle diameter in the range of 0.1 μm to 5 μm on the first polycrystalline diamond layer; and a second sintering step of sintering the assembled carbide substrate, the first polycrystalline diamond layer, and the second diamond powder on the first polycrystalline diamond layer to form a second polycrystalline diamond layer on the first polycrystalline diamond layer.

The method may further include a step of preparing the first diamond power in which the particle size of the first diamond powder is determined in a range of 0.1 μm to 40 μm so that the entire thickness of the first polycrystalline diamond layer and the second polycrystalline diamond layer is inversely proportional to the thickness of the second polycrystalline diamond layer.

The method may further include a step of preparing the first diamond power in which the particle size of the first diamond powder is determined in a range of 15 μm to 40 μm so that the entire thickness of the first polycrystalline diamond layer and the second polycrystalline diamond layer is inversely proportional to the thickness of the second polycrystalline diamond layer.

The thickness of the second polycrystalline diamond layer may be determined in a range of 20% to 25% of a ratio to the entire thickness of the first polycrystalline diamond layer and the second polycrystalline diamond layer.

Another aspect of the present invention provides a polycrystalline diamond compact, comprising: a carbide substrate; a first polycrystalline diamond layer which is formed on the carbide substrate by sintering a first diamond powder in which a particle size is in a range of 0.1 μm to 40 μm and contains a metal binder having a first content (wt %) released from the carbide substrate during sintering; and a second polycrystalline diamond layer which is formed on the first polycrystalline diamond layer by sintering a second diamond powder in which a particle size is in a range of 0.1 μm to 5 μm, released from the first polycrystalline diamond layer during sintering, and contains a metal binder having a second content (wt %) lower than the first content (wt %).

The first content and the second content may be the contents of the upper parts of the first polycrystalline diamond layer and the second polycrystalline diamond layer, respectively.

The particle diameter of the first diamond powder may be in a range of 15 μm to 40 μm and the second content is 2 to 4 wt %.

The particle diameter of the first diamond powder may be in a range of 5 μm to 15 μm and the second content is 4 to 5 wt %.

The particle diameter of the first diamond powder may be in a range of 0.1 μm to 5 μm and the second content is 5 to 8 wt %.

The diameter of the second polycrystalline diamond particle may be equal to or greater than the diameter of the first polycrystalline diamond.

The thickness of the second polycrystalline diamond layer may be smaller than the thickness of the first polycrystalline diamond layer.

The thickness of the second polycrystalline diamond layer may be formed in a range of 20% to 25% of a ratio to the entire thickness of the first polycrystalline diamond layer and the second polycrystalline diamond layer.

### Advantageous Effects

According to the present invention, the content of a metal binder (catalyst) in a portion which is used in bedrock cutting during actual drilling, that is, a superficial portion of the polycrystalline diamond layer, is controlled to be minimized, thereby increasing heat resistance and improving wear resistance and impact resistance.

Further, the sizes of the diamond particles included in the superficial portion of the polycrystalline diamond layer are smaller than those of diamond particles included in an internal layer of the polycrystalline diamond layer to increase wear resistance. In addition, the sizes of the diamond particles of the internal layer of the polycrystalline diamond layer are larger than those of the diamond particles included in the superficial portion to absorb the impact from the interior, thereby improving impact resistance against impact which may be generated during operating.

Further, the thickness of the superficial portion (the second polycrystalline diamond layer) is minimized while introducing a multilayered structure with balanced heat resistance, wear resistance, and impact resistance, thereby improving sinterability so as to solve structural instability due to the multilayered structure.

### DESCRIPTION OF DRAWINGS

FIG. 1 is a cross-sectional view illustrating an appearance of a polycrystalline diamond compact according to an exemplary embodiment.

FIG. 2 is a cross-sectional view illustrating an appearance a polycrystalline diamond compact according to another exemplary embodiment.

FIG. 3 is a scanning electron microscope (SEM) photograph illustrating an appearance of a superficial portion of a second polycrystalline diamond layer.

FIG. 4 is a flowchart illustrating a method for manufacturing a polycrystalline diamond compact according to an exemplary embodiment.

FIGS. 5 and 6 are SEM photographs illustrating a superficial portion of a first polycrystalline diamond layer.

FIG. 7 is a graph illustrating a volume loss due to friction to an operated object.

### BEST MODE OF INVENTION

A method for manufacturing a polycrystalline diamond compact, according to the present invention, comprises: a first assembling step of assembling a first diamond powder on a carbide substrate; a first sintering step of preliminarily sintering the assembled carbide substrate and the first diamond powder on the carbide substrate to form a first polycrystalline diamond layer on the carbide substrate; a second assembling step of assembling a second diamond powder having a particle diameter in the range of 0.1 μm to 5 μm on the first polycrystalline diamond layer; and a second sintering step of sintering the assembled carbide substrate, the first polycrystalline diamond layer, and the second diamond powder on the first polycrystalline diamond layer to form a second polycrystalline diamond layer on the first polycrystalline diamond layer.

### Description of Embodiment(s)

Hereinafter, exemplary embodiments of the present invention will be described in detail with reference to the accompanying drawings. If not particularly defined or mentioned, a term indicating a direction used in the present description is based on a state illustrated in the drawings. Further, through each exemplary embodiment, like reference numerals denote like elements. Meanwhile, the thickness or size of each component illustrated in the drawings may be exaggerated for easy description and does not mean that the thickness or size should be configured by a ratio between the corresponding size or component.

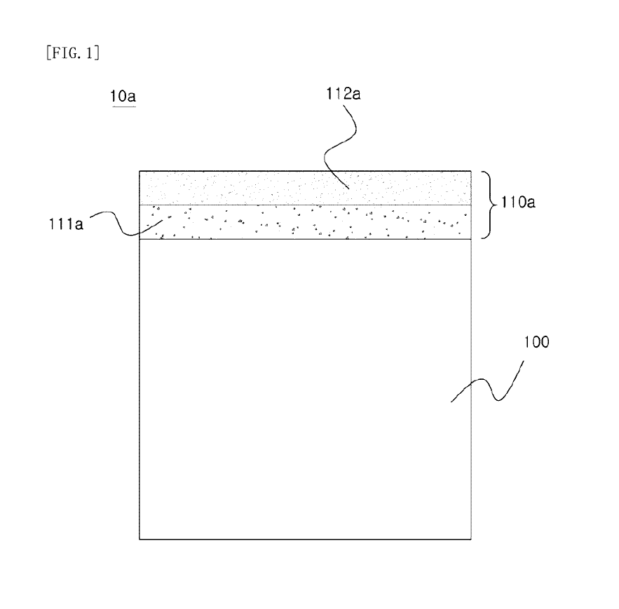

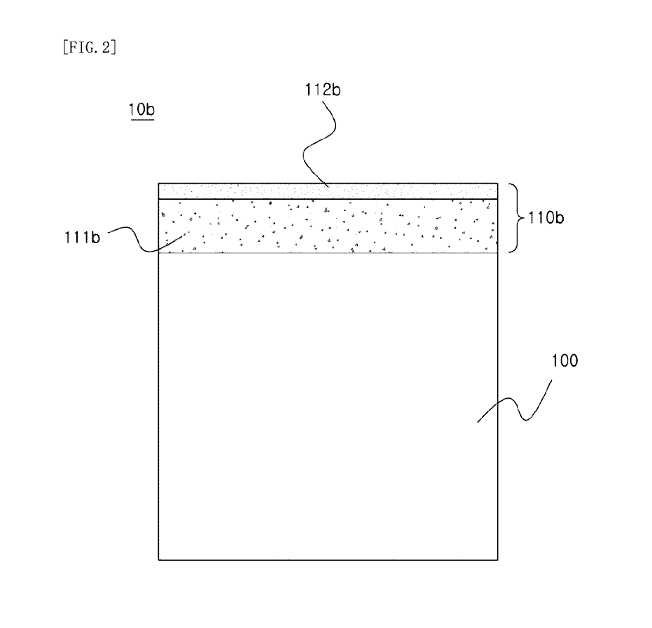

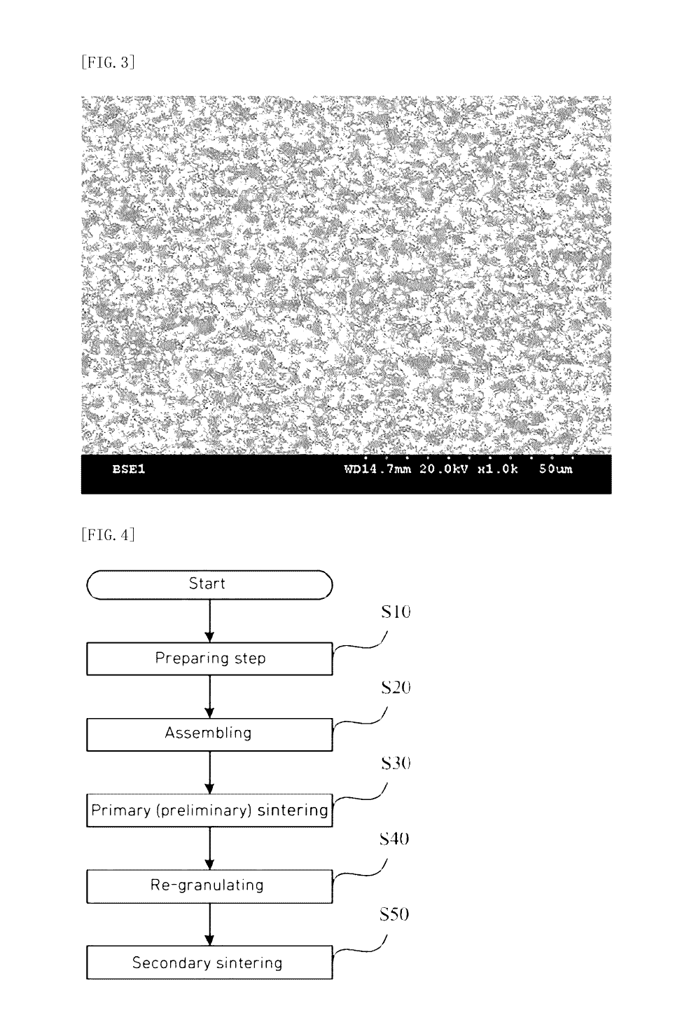

A polycrystalline diamond compact according to an exemplary embodiment will be described with reference to FIGS. 1 to 3. FIG. 1 is a cross-sectional view illustrating an appearance of a polycrystalline diamond compact according to an exemplary embodiment, FIG. 2 is a cross-sectional view illustrating an appearance a polycrystalline diamond compact according to another exemplary embodiment, and FIG. 3 is a scanning electron microscope (SEM) photograph illustrating an appearance of a superficial portion of a second polycrystalline diamond layer.

A polycrystalline diamond compact manufactured by a method for manufacturing the polycrystalline diamond compact according to an exemplary embodiment is illustrated in FIGS. 1 and 2.

In a polycrystalline diamond compact 10a according to the exemplary embodiment, a polycrystalline diamond layer 110a is formed on a carbide substrate 100 and the polycrystalline diamond layer 110a is formed with a multilayered structure of a first polycrystalline diamond layer 111a and a second polycrystalline diamond layer 112a.

The carbide substrate 100 is compressed at high pressure and heated at a high temperature at which the metal is not dissolved to be sintered and formed by using compound powder such as tungsten carbide and titanium carbide and metal powder such as cobalt as a coupling agent. In addition, WC—TiC—Co, WC—TiC—Ta(NbC)—Co, WC—TaC(NbC)—Co, and the like may be used.

The first polycrystalline diamond layer 111a is a layer formed by sintering a first diamond powder and a metal binder released from the carbide substrate 100, for example, cobalt (Co) under high temperature and high pressure and has the content of the metal binder of approximately 4 to 15 wt %.

The second polycrystalline diamond layer 112a is a layer formed by sintering a second diamond powder and a metal binder released from the first polycrystalline diamond layer under high temperature and high pressure and has the content of the metal binder of approximately 2 to 8 wt %.

Meanwhile, as illustrated in FIG. 2, a second polycrystalline diamond layer 112b may be formed with a thickness smaller than that of a first polycrystalline diamond layer 111b.

Further, as illustrated in FIG. 3, bright-colored cobalt forms a pool between the diamond particles represented by a dark color in the first polycrystalline diamond layer 111b and the second polycrystalline diamond layer 112b. Hereinafter, the accompanying SEM photographs illustrate that cobalts form the pool between the diamond particles.

Particular features including particle sizes of respective diamond powders for forming the first polycrystalline diamond layer and the second polycrystalline diamond layer, thicknesses of the first polycrystalline diamond layer and the second polycrystalline diamond layer, and the like will be described below in detail in addition to the manufacturing method.

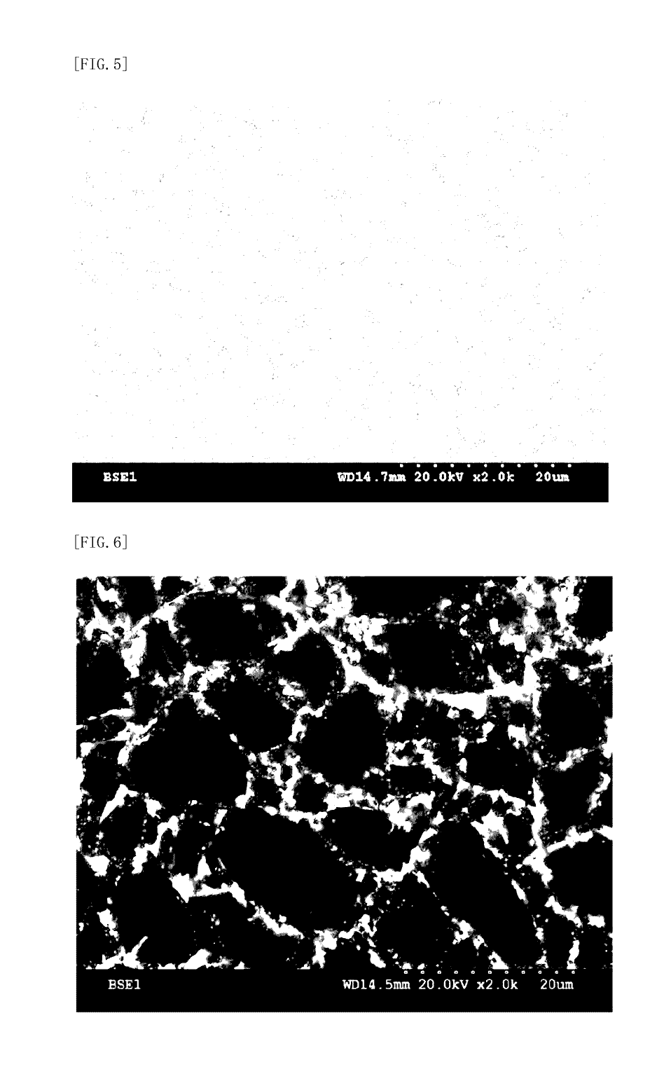

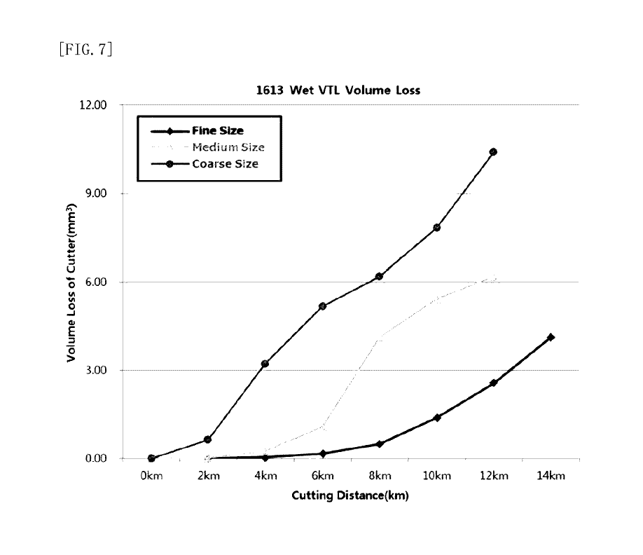

A method for manufacturing a polycrystalline diamond compact according to an exemplary embodiment will be described with reference to FIGS. 4 to 7. FIG. 4 is a flowchart illustrating a method for manufacturing a polycrystalline diamond compact according to an exemplary embodiment, FIGS. 5 and 6 are SEM photographs illustrating a superficial portion of a first polycrystalline diamond layer, and FIG. 7 is a graph illustrating a volume loss due to friction to an operated object.

First, in a preparing step, a carbide substrate and a first diamond powder are prepared (S10). In this case, a diamond sintered body which mixes the metal binder with the diamond powder may be manufactured, but in the present invention, products which need not to mix the metal binder with the polycrystalline diamond compact, that is the diamond powder, separately are particularly meaningful.

The polycrystalline diamond sintered body (PCD) needs to be cut in a process of manufacturing a product, and thus cutting needs to be easy because of the metal binder is included in the diamond powder. However, the polycrystalline diamond compact (PDC) according to the exemplary embodiment, cutting is not required and thus as the metal binder for binding the diamond particles during sintering, a metal component implemented from the carbide substrate is used.

Hereinafter, for convenience for description, as a metal binder (catalyst) lifted from the carbide substrate to be used for sintering the diamond powder, cobalt (Co) will be described as an example. In addition to cobalt, a component such as nickel (Ni), silicon (Si), and titanium (Ti) may be used as the binder. Cobalt lifted to the diamond layer from the carbide substrate during sintering can not be physically controlled and coagulation of cobalt is shown in the diamond sintered body structure. The sintering of the diamond and the cobalt as the metal catalyst has a large difference in thermal expansion coefficient and thus becomes a main factor of generating cracks and breakage of the sintered polycrystalline diamond compact product. In order to minimize the cracks and breakage, only the content required for implementing sintering and characteristics of the product needs to be distributed in the diamond layer by controlling the content of cobalt.

The cemented carbide means cemented carbide which is compressed at high pressure and heated at a high temperature at which the metal is not dissolved to be sintered and formed by using compound powder such as tungsten carbide and titanium carbide having very high hardness and metal powder such as cobalt as a coupling agent. That is, the cemented carbide is manufactured by sintering (powder metallurgy) at a high temperature by adding several to tens % of metal (Co, Ni, and the like) having relatively toughness to micropowder of carbides of hard high-melting point metal (W, Ti, and the like). In addition, WC—TiC—Co, WC—TiC—Ta(NbC)—Co, and WC—TaC(NbC)—Co are used.

It is preferred that the sizes of the particles of the first diamond powder are larger than those of the particles of the second diamond powder included during reassembling for sintering the second polycrystalline diamond layer.

When other conditions such as the content of cobalt are the same, the polycrystalline diamond layer containing the diamond particles having small sizes has relatively improved wear resistance as compared with the polycrystalline diamond layer containing the diamond particles having large sizes, whereas the polycrystalline diamond layer containing the diamond particles having large sizes has relatively improved impact resistance as compared with the polycrystalline diamond layer containing the diamond particles having small sizes.

That is, in order to form the first polycrystalline diamond layer so as to absorb predetermined impact corresponding to external impact during operation, the particle sizes of the first diamond powders are in a range of 0.1 to 5 μm and larger than those of the second diamond powders.

Next, the first diamond powders are assembled on the carbide substrate with a shape of the polycrystalline diamond compact to be manufactured (S20), and then primary sintering is performed while the first diamond powders are assembled on the carbide substrate to form the first polycrystalline diamond layer on the carbide substrate (S30).

The sintering in the exemplary embodiment is performed under high pressure of approximately 5 to 6 GPa and a high temperature of approximately 1500° C. However, the condition of the high temperature and high pressure may vary according to a characteristic of the final product to be manufactured and is not limited.

2000 times enlarged SEM photographs of the upper surface of the first polycrystalline diamond layer are divided and illustrated in FIGS. 5 and 6 according to the particle size of the first diamond powder and measured results using X-ray energy-dispersive spectrometry (EDS) are illustrated in Tables 1 to 3. Table 1 illustrates a result of analyzing a superficial portion of a first polycrystalline diamond layer when sintering by using a first diamond powder having a fine size, that is, a particle size of 0.1 to 5 μm, Table 2 illustrates a result of analyzing a superficial portion of a first polycrystalline diamond layer when sintering by using a first diamond powder having a medium size, that is, a particle size of 5 to 15 μm, and Table 3 illustrates a result of analyzing a superficial portion of a first polycrystalline diamond layer when sintering by using a first diamond powder having a coarse size, that is, a particle size of 15 to 40 μm. Meanwhile, the aforementioned particle size means an average particle size other than a condition for all particles included each powder.

TABLE 1

| Component | Wt % |
|---|---|
| C | 84.75 |
| Co | 11.98 |
| W | 3.27 |

TABLE 2

| Component | Wt % |
|---|---|
| C | 87.58 |
| Co | 9.97 |
| W | 2.45 |

TABLE 3

| Component | Wt % |
|---|---|
| C | 91.72 |
| Co | 5.88 |
| W | 2.40 |

As illustrated in FIGS. 5 and 6, as the particle size of the first diamond powder is increased, the distribution size of the diamonds distributed in the first polycrystalline diamond layer after sintering, and as illustrated in Tables 1 to 3, as the particle size of the first diamond powder is decreased, the content (wt %) of cobalt (Co) is increased.

As such, in the first polycrystalline diamond layer, the content of cobalt released from the carbide substrate may be adjusted by controlling the particle size of the diamond powder before sintering, and the result is illustrated in the following Table 4 (the content of the binder is represented by wt %).

TABLE 4

| Layer | Particle size | Binder content |
|---|---|---|
| First | Fine Size (0.1-5 μm) | 10-15% |
| diamond | Medium Size (5-15 μm) | 8-10% |
| layer | Coarse Size (15-40 μm) | 4-8% |

In this case, as described above, in order to satisfy constant impact resistance within the purpose of the final product, it should be considered that the particle size of the first diamond powder is larger than the particle size of the second diamond powder.

Next, the second diamond powders are reassembled on the formed first polycrystalline diamond layer (S40) and then the secondary sintering is performed (S50). In the exemplary embodiment, the secondary sintering is performed under the same condition as the primary sintering described above, but may be changed according to the characteristic of the final product like the primary sintering and is not particularly limited.

Meanwhile, the particle size of the second diamond powders is limited to a fine size (0.1 to 5 μm). Referring to FIG. 7, as a result of performing an experiment related with the wear after manufacturing the polycrystalline diamond compact by using the diamond powders for each size, in the case of manufacturing the polycrystalline diamond compact by using a diamond powder having a coarse size, a volume loss is approximately 5.3 times higher than a case of manufacturing the polycrystalline diamond compact by using a diamond powder having a fine size on a cutting distance of approximately 10 km. That is, as the experiment result, it can be seen that as the size of the diamond particle is decreased, wear resistance is improved.

As the particle size of the diamond powder used when the polycrystalline diamond compact is sintered is decreased, the content of the metal binder after sintering is increased, and thus heat resistance is slightly reduced. However, for this reason, that is, in order to improve wear resistance, due to a characteristic of the polycrystalline diamond compact used in the cutter, it is preferred that the particle size of the second diamond powder used in direct cutting is limited to the fine size.

In the following Table 5, the content of the binder of the second polycrystalline diamond layer manufactured by using the diamond particles having the fine size, that is, the released amount is represented for each size of the first diamond size used when sintering the first diamond layer.

TABLE 5

| Layer | Particle size | Content of binder |
|---|---|---|
| Second | Fine Size (0.1-5 μm) | 5-8% |
| diamond | Medium Size (5-15 μm) | 4-5% |
| layer | Coarse Size (15-40 μm) | 2-4% |

Meanwhile, the thicknesses of the first polycrystalline diamond layer and the second polycrystalline diamond layer may be formed at a predetermined ratio. Particularly, the thickness of the second polycrystalline diamond layer may be formed in a range of 20 to 25% of the entire thickness of the first polycrystalline diamond layer and the second polycrystalline diamond layer. In the polycrystalline diamond compact, generally, the thickness of the polycrystalline diamond layer is approximately 2 mm, and in this case, the thickness of the second polycrystalline diamond layer may be 0.4 to 0.5 mm.

When the thickness of the second polycrystalline diamond layer is greater than 25%, sinterability is deteriorated, and thus stability of the multilayered structure constituted by the first polycrystalline diamond layer and the second polycrystalline diamond layer is decreased. When the thickness thereof is smaller than 20%, structural stability as a cut edge portion of the polycrystalline diamond compact to be manufactured is decreased and durability is deteriorated.

That is, when the thickness of the second polycrystalline diamond layer is in the range of 20 to 25% of the entire thickness of the first polycrystalline diamond layer and the second polycrystalline diamond layer, the sinterability is increased, the content of the binder of the second polycrystalline diamond layer is easily controlled, and durability for serving as the cut edge portion may be improved.

As a result, according to a purpose, the size of the diamond particle included in the second polycrystalline diamond layer is different from the size of the diamond particle included in the first polycrystalline diamond layer to produce tools suitable for various purposes. However, particularly, like the case of operating by using the tool including the polycrystalline diamond compact according to the present invention, when external friction is large and large impact is generated, the characteristic of the second polycrystalline diamond layer needs to be controlled in a direction of reinforcing impact resistance and heat resistance.

That is, as the most preferable embodiment, the second polycrystalline diamond layer is formed as the polycrystalline diamond layer of which the thickness is small and the sizes of the included polycrystalline diamond particles are relatively small and the content of the metal binder distributed in the final second polycrystalline diamond layer is controlled to be relatively smaller than the content of the metal binder distributed in the first polycrystalline diamond layer, thereby reducing a breakage risk such as cracks in response to the heat generated by friction with the operated objected and maintaining structural stability even in external impact.

As described above, for a partial purpose, only the content of the metal binder of the second polycrystalline diamond layer is controlled to be smaller than the content of the metal binder of the first polycrystalline diamond layer. Furthermore, of course, a relative thickness of the second polycrystalline diamond layer may be controlled or the sizes of the diamond particles included in the second polycrystalline diamond layer may be controlled.

Although preferable embodiments of the present invention have been exemplarily described as above, the technical spirit of the present invention is limited to the preferable embodiments and the present invention can be variously implemented within the scope without departing from the spirit of the present invention which is specifically described in the appended claims.

### INDUSTRIAL APPLICABILITY

1. A method for manufacturing a polycrystalline diamond compact, the method comprising: a first assembling step of assembling a first diamond powder on a carbide substrate; a first sintering step of preliminarily sintering the assembled carbide substrate and the first diamond powder on the carbide substrate to form a first polycrystalline diamond layer on the carbide substrate; a second assembling step of assembling a second diamond powder having a particle diameter in the range of 0.1 μm to 5 μm on the first polycrystalline diamond layer; and a second sintering step of sintering the assembled carbide substrate, the first polycrystalline diamond layer, and the second diamond powder on the first polycrystalline diamond layer to form a second polycrystalline diamond layer on the first polycrystalline diamond layer.

2. The method of claim 1, further comprising: a step of preparing the first diamond power in which the particle size of the first diamond powder is determined in a range of 0.1 μm to 40 μm so that the entire thickness of the first polycrystalline diamond layer and the second polycrystalline diamond layer is inversely proportional to the thickness of the second polycrystalline diamond layer.

3. The method of claim 2, further comprising: a step of preparing the first diamond power in which the particle size of the first diamond powder is determined in a range of 15 μm to 40 μm so that the entire thickness of the first polycrystalline diamond layer and the second polycrystalline diamond layer is inversely proportional to the thickness of the second polycrystalline diamond layer.

4. The method of claim 2, wherein the thickness of the second polycrystalline diamond layer is determined in a range of 20% to 25% of a ratio to the entire thickness of the first polycrystalline diamond layer and the second polycrystalline diamond layer.

5. A polycrystalline diamond compact, comprising: a carbide substrate; a first polycrystalline diamond layer which is formed on the carbide substrate by sintering a first diamond powder in which a particle size is in a range of 0.1 μm to 40 μm and contains a metal binder having a first content (wt %) released from the carbide substrate during sintering; and a second polycrystalline diamond layer which is formed on the first polycrystalline diamond layer by sintering a second diamond powder in which a particle size is in a range of 0.1 μm to 5 μm, released from the first polycrystalline diamond layer during sintering, and contains a metal binder having a second content (wt %) lower than the first content (wt %).

6. The polycrystalline diamond compact of claim 5, wherein the first content and the second content are the contents of the upper parts of the first polycrystalline diamond layer and the second polycrystalline diamond layer, respectively.

7. The polycrystalline diamond compact of claim 6, wherein the particle diameter of the first diamond powder is in a range of 15 μm to 40 μm and the second content is 2 to 4 wt %.

8. The polycrystalline diamond compact of claim 6, wherein the particle diameter of the first diamond powder is in a range of 5 μm to 15 μm and the second content is 4 to 5 wt %.

9. The polycrystalline diamond compact of claim 6, wherein the particle diameter of the first diamond powder is in a range of 0.1 μm to 5 μm and the second content is 5 to 8 wt %.

10. The polycrystalline diamond compact of claim 5, wherein the diameter of the second polycrystalline diamond particle is equal to or greater than the diameter of the first polycrystalline diamond.

11. The polycrystalline diamond compact of claim 5, wherein the thickness of the second polycrystalline diamond layer is smaller than the thickness of the first polycrystalline diamond layer.

12. The polycrystalline diamond compact of claim 11, wherein the thickness of the second polycrystalline diamond layer is formed in a range of 20% to 25% of a ratio to the entire thickness of the first polycrystalline diamond layer and the second polycrystalline diamond layer.

13. The method of claim 3, wherein the thickness of the second polycrystalline diamond layer is determined in a range of 20% to 25% of a ratio to the entire thickness of the first polycrystalline diamond layer and the second polycrystalline diamond layer.
